(19) United States
(12) Patent Application Publication
(10) Pub. No.: US 2011/0188147 A1
(43) Pub. Date: Aug. 4, 2011

(54) METHOD ADJUSTING GAIN OF VARIABLE GAIN AMPLIFIER AND APPARATUS USING SAME

(75) Inventors: Joo Won CHO, Gwacheon-si (KR); Seung Youl JEONG, Hwaseong-si (KR)

(73) Assignee: SAMSUNG ELECTRONICS CO., LTD., Suwon-si (KR)

(21) Appl. No.: 13/019,339

(22) Filed: Feb. 2, 2011

(30) Foreign Application Priority Data
Feb. 4, 2010 (KR) 10-2010-0010349

(51) Int. Cl. G11B 5/09

(52) U.S. Cl. 360/46; G9B/5.033

(57) ABSTRACT

A method of adjusting gain of a variable gain amplifier of a read/write channel circuit includes loading a first VGA gain value that is read channel optimized, in a first register, loading a second VGA gain value that is adapted, in a second register, calculating a third VGA gain value according to a result of operation of the first VGA gain value and the second VGA gain value, and overwriting the third VGA gain value to the first register.

### CROSS-REFERENCE TO RELATED APPLICATIONS

This application claims priority under 35 U.S.C. §119(a) to Korean Patent Application No. 10-2010-0010349 filed on Feb. 4, 2010, the subject matter of which is hereby incorporated by reference.

### BACKGROUND

The inventive concept relates to gain adjustment technology for a variable gain amplifier (VGA), and more particularly, to a method for adjusting the gain of a VGA embodied in a read/write channel circuit of a hard disk drive (HHD), as well as an apparatus using the method.

VGAs vary their gain within a defined control voltage. To appropriately adjust gain of a VGA, it is necessary to appropriately adjust the control voltage.

### SUMMARY

The inventive concept provides a method of adjusting a gain value to prevent divergence of a gain value of the variable gain amplifier, and for performing the method, and a data storage device including this type of circuit.

According to one aspect of embodiments of the inventive concept, there is provided a method of adjusting gain of a variable gain amplifier (VGA) in a read/write channel circuit, the method including; loading a first VGA gain value (V1) that is initially optimized to a read channel of the read/write circuit in a first register, loading a second VGA gain value (V2) that is adapted from V1 in a second register, determining a third VGA gain value (V3) in accordance with results of operation of the VGA using V1 and V2, and overwriting V1 with V3 in the first register.

Loading V1 in the first register may be performed during a first time period in which a first current read gate is enabled.

Loading V2 in the second register may be performed after the first time period and before a second time period in which a second current read gate is enabled.

The method may further include setting V2 or V3 to be a gain value controlling the operation of the VGA.

As examples, if V2 is greater than 0.8 times V1 and less than 0.9 times V1, V3 may be calculated to be equal to ½ a sum of V1 and V2. If V2 is greater than 0.9 times V1 and less than 1.1 times V1, V3 may be determined to be equal to V2. If V2 is greater than 1.1 times V1 and less than 1.2 times V1, V3 may be calculated to be equal to ½ a sum of V1 and V2. If V2 is less than 0.8 times V1, V3 may be calculated to be equal to 0.8 time V1. If V2 is greater than 1.2 times V1, V3 may be calculated to be equal to 1.2 times V1.

In another aspect, embodiments of the inventive concept provide a read/write channel circuit including; a first register that stores a first variable gain amplifier (VGA) gain value (V1) that is read channel optimized, a second register that stores a second VGA gain value (V2) that is adapted from V1, and a controller that reads V1 and V2, determines a third VGA gain value (V3) according to results of operation of the VGA in accordance with V1 and V2, and overwrites V1 in the first register with V3.

The controller may further set V2 or V3 as a gain value of the VGA in the read/write channel circuit.

According to another aspect, embodiments of the inventive concept provide a hard disk drive (HHD) including; a magnetic recording medium that stores data, a spindle motor that rotates the magnetic recording medium, a head that at least one of amplifies a write signal to write the data to the magnetic recording medium and reads data from the magnetic recording medium, a pre-amplifier that at least one of amplifies a write signal to write the data via the head and amplifies a read signal output from the head, and a read/write channel circuit that converts a signal output from the pre-amplifier into read data. The read/write channel circuit includes; a variable gain amplifier (VGA) that amplifies the signal output from the pre-amplifier, a first register that stores a first VGA gain value (V1) that is read channel optimized, a second register that stores a second VGA gain value (V2) that is adapted from V1, and a controller that reads V1 and V2, determines a third VGA gain value (V3) in accordance with results of operation of the VGA using V1 and V2, overwrites V1 in the first register with V3, and sets V2 or V3 as a gain value controlling operation of the VGA.

According to another aspect of the inventive concept, there is provided a computational system that includes the above hard disk drive and a host for exchanging data with the hard disk drive.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a hard disk drive including a read/write channel circuit according to an embodiment of the inventive concept;

FIG. 2 is a circuit diagram illustrating an automatic gain controller and a variable gain amplifier (VGA), according to an embodiment of the inventive concept;

FIG. 3 is a flowchart for explaining a method of adjusting gain of the VGA according to an embodiment of the inventive concept;

FIG. 4 illustrates a calculation reference of the third VGA gain value according to an embodiment of the inventive concept;

FIG. 5 is a timing diagram for explaining an operation method of a hard disk drive that performs the VGA gain adjustment method explained in FIGS. 1-4; and

FIG. 6 is a block diagram of a computer system including the hard disk drive of FIG. 1.

### DETAILED DESCRIPTION OF THE EMBODIMENTS

The attached drawings for illustrating embodiments of the inventive concept are referred to in order to gain a sufficient understanding of the inventive concept and the merits thereof Hereinafter, the inventive concept will be described in some additional detail with reference to the embodiments illustrated in the attached drawings. Throughout the drawings and written description, like reference numbers and labels are used to denote like or similar elements.

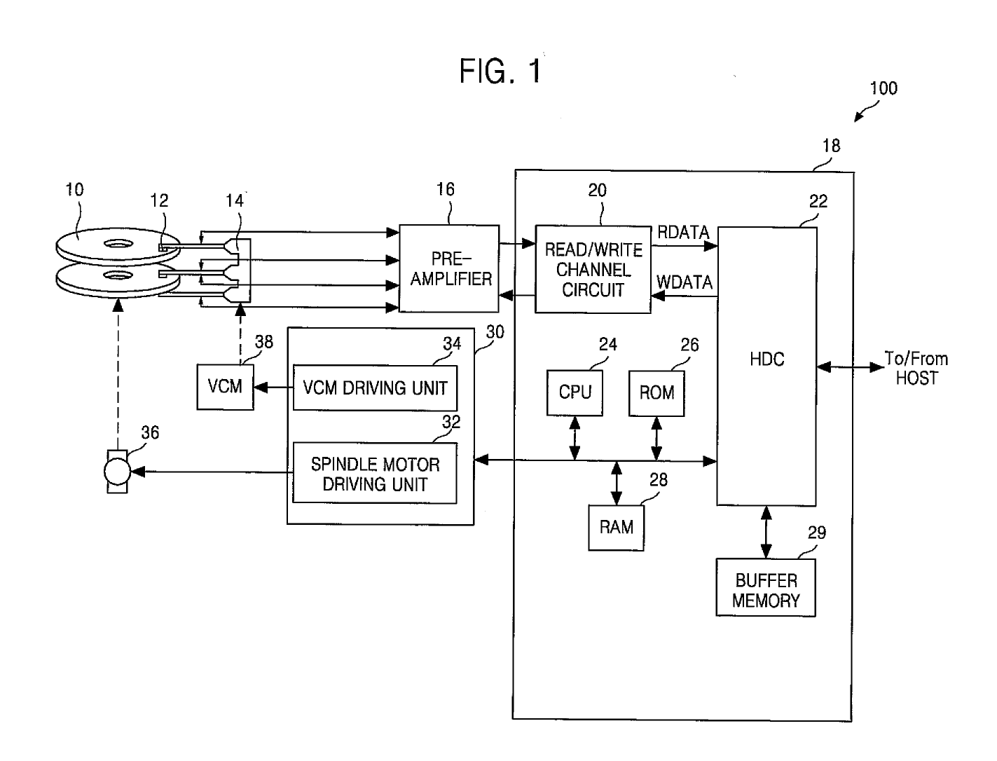

Figure (FIG.) 1 is a block diagram of a hard disk drive (HDD) 100 including a read/write channel circuit according to an embodiment of the inventive concept. Referring to FIG. 1, the exemplary HDD 100 comprises a plurality of disks 10, a plurality of heads 12, a head assembly 14, a pre-amplifier 16, a main control unit 18, a motor driving unit or servo control unit 30, a spindle motor 36, and a voice coil motor (VCM) 38.

Each of the disks 10 may be used to store data output from a host, the plurality of disks 10 are collectively rotated by the spindle motor 36. Each of the disks 10 may be embodied by a magnetic recording medium. Each of the heads 12 is located above a surface of a corresponding one of the disks 10, and is configured to perform read operations and/or write operations. The plurality of heads 12 may be respectively installed in the HDD 100 at the end of a support arm (not shown) extending to the plurality of disks 10 from the head assembly 14 that is connected to the VCM 38.

When reading data stored on a disk, the pre-amplifier 16 amplifies an analog signal output by one of the plurality of heads 12 and provides an amplified analog signal to a read/write channel circuit 20. When writing data to the disk, the pre-amplifier 16 transmits a write signal provided from the read/write channel circuit 20, (e.g., a write current), to one of the plurality of heads 12. Thus, any one of the plurality of heads 12 may be used to write data according to the write signal to any one of the plurality of disks 10.

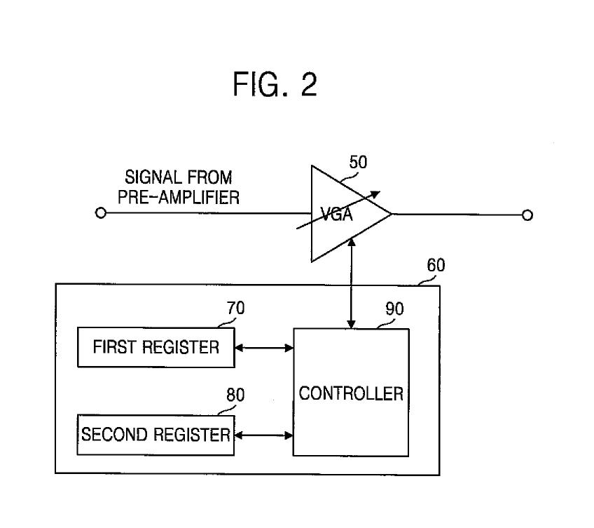

The read/write channel circuit 20 converts the analog signal amplified by the pre-amplifier 16 into a digital signal and provides the corresponding digital signal to a hard disk controller (HDC) 22. The read/write channel circuit 20 may be used to control a gain value for a variable gain amplifier. (See, e.g., VGA 50 of FIG. 2). In this manner, any divergence of the gain value for the VGA 50 due to some kind of malfunction or operation outside a defined operating range within the main control unit 18 may be prevented.

The read/write channel circuit 20 may be used to convert write data provided from the HDC 22 into the write signal and output a converted write signal to the pre-amplifier 16. For example, when data is written to the plurality of disks 10, the HDC 22 outputs externally provided write data to the read/write channel circuit 20 under the control of a central processing unit (CPU) 24. Thus, the write data, as proved from the host, may be written to any one of the plurality of disks 10 via any one of the plurality of heads 12 via the read/write channel circuit 20 and the pre-amplifier 16.

When data is read from one of the plurality of disks 10, the HDC 22 may be used to receive read data decoded by the read/write channel circuit 20, perform error correction with respect to received read data, and transmit error corrected data to the host.

The CPU 24 may be used to receive an externally provided read command or write command to control a spindle motor driving unit 32 and a VCM driving unit 34 in order to perform track seek and/or track following functions in accordance with the received command. The spindle motor driving unit 32 controls the operation of the spindle motor 36 that controls the rotation of the plurality of disks 10 in response to at least one control signal provided from the HDC 22. The VCM driving unit 34 generates a driving current to drive the VCM 38 and outputs a generated driving current to a voice coil of the VCM 38 in response to the control signal provided from the HDC 22, (e.g., a control signal defining the particular location of one or more of the plurality of heads 12).

For example, the VCM 38 may move a selected head 12 currently being used to follow a track on a selected disk 10 in accordance with the direction and level of the driving current provide by the VCM driving unit 34. In certain embodiments, a buffer memory 29 that may be included within (or external to) the main control unit 18 to temporarily store data exchanged between the HDD 100 and the host. The buffer memory 29 may be implemented using a volatile memory device, such as a DRAM or SDRAM.

In certain embodiments, the main control unit 18 incorporating the read/write channel circuit 20, the HDC 22, the CPU 24, a read only memory (ROM) 26, a random access memory (RAM) 28, and the buffer memory 29 may be implemented using a single integrated circuit substrate (or “chip”), for example, a system-on-chip (SoC). Also, the motor driving unit 30 including the spindle motor driving unit 32 and the VCM driving unit 34 may be implemented using a single chip, for example, a system-on-chip (SoC).

FIG. 2 is a circuit diagram further illustrating the read/write channel circuit 20 of FIG. 1 including an automatic gain controller 60 and the VGA 50. Referring to FIGS. 1 and 2, the read/write channel circuit 20 generally comprises the VGA 50 and the automatic gain controller (AGC) 60. The VGA 50 amplifies a signal provided by the pre-amplifier 16 based on a gain control signal of the AGC 60.

In the particular illustrated embodiment of FIG. 2, the AGC 60 comprises a first register 70, a second register 80, and a controller 90.

When the head 12 reads a first sector by changing any zone of the disks 10, it is assumed that the first register 70 initially stores a first VGA gain value that has been read channel optimized (RCO) under the control of the controller 90. However, when the first sector is completely read, the second register 80 stores a second VGA gain value that is adapted under the control of the controller 90.

The controller 90 reads and controls operation of the VGA 50 in accordance with the first and second VGA gain values. The controller 90 then determines a third VGA gain value in view of these operating conditions and writes the third VGA gain value to the first register 70 to replace (or overwrite) the first VGA gain value.

In certain more particular embodiments, if the second VGA gain value is greater than 0.8 times the first VGA gain value but less than 0.9 times the first VGA gain value, then the controller 90 determines the third VGA gain value as being equal to ½ the sum of the first and second VGA gain values.

In other more particular embodiments, if the second VGA gain value is greater than 0.9 times the first VGA gain value but less than 1.1 times the first VGA gain value, the controller 90 determines the third VGA gain value to be equal to the second VGA gain value.

In still other more particular embodiments, if the second VGA gain value is greater than 1.1 times the first VGA gain value but less than 1.2 times the first VGA gain value, the controller 90 again determines the third VGA gain value as being equal to ½ the sum of the first and second VGA gain values.

In still other more particular embodiments, if the second VGA gain value is less than 0.8 times the first VGA gain value or greater than 1.2 times the first VGA gain value, the controller 90 determines the third VGA gain value to be equal to either 0.8 times the first VGA gain value, or 1.2 times of the first VGA gain value.

In certain embodiments, the controller 90 may set the second VGA gain value or the third VGA gain value as the gain value for the VGA 50. To set the second VGA gain value or the third VGA gain value as the gain value of the VGA 50, the AGC 60 may further include a third register (not shown) for the above setting.

The controller 90 may therefore determine the exact gain value for the VGA 50 according to changeable gain values stored in a plurality of programmable registers. Assuming a particular and exemplary configured of three (3) gain value registers, when the controller 90 sets the gain value stored in the third register to “1”, the third VGA gain value overwritten to the first register 70 in the above example may be used as the gain value for the VGA 50. However, when the controller 90 sets the gain value stored in the third register to “0”, the second VGA gain value previously stored in the second register 80 may be used as the gain value for the VGA 50.

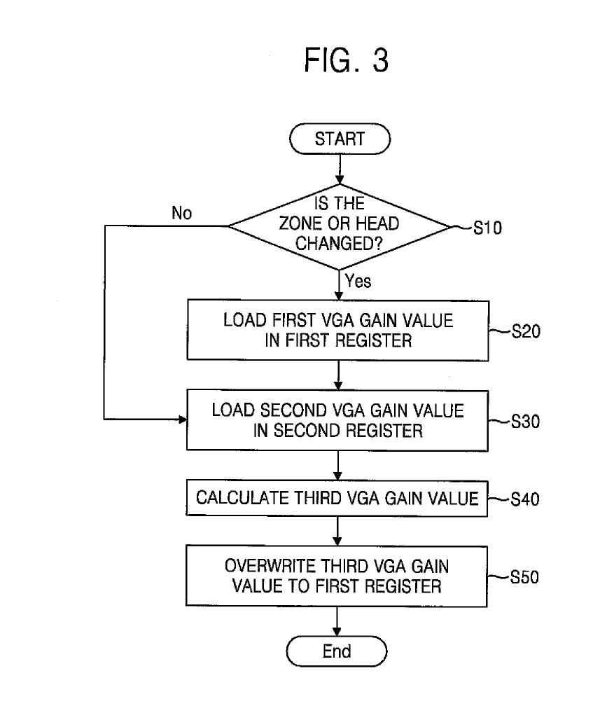

FIG. 3 is a flowchart summarizing a method of adjusting the gain for the VGA 50 according to certain embodiments of the inventive concept. Referring to FIGS. 1-3, the read/write channel circuit 20 first determines whether the head 12 reads a first sector following a change in zone of the disks 10 or a change in head (S10).

When the head 12 reads the first sector upon changing zones of the disks 10, the controller 90 stores (or loads) a first VGA gain value (e.g., a gain value assumed to optimize channel performance) to a first register first register 70 (S20). After reading the first sector, the controller 90 loads the second VGA gain (e.g., a gain value further adapted) in the second register 80 (S30). When the head 12 reads the first sector without changing a zone of the disks 10, the controller 90 immediately loads the second VGA gain value in the second register 80 without performing step S20.

The controller 90 then determines (e.g., calculates) a third VGA gain value according to the results of the operations performed using the first and second VGA gain values (S40). The controller 90 then overwrites a calculated third VGA gain value to the first register 70 (S50). However, in certain embodiments, the controller 90 may load additional registers such that the first VGA gain value, second VGA gain value, or third VGA gain value may be set as the gain value for the VGA 50.

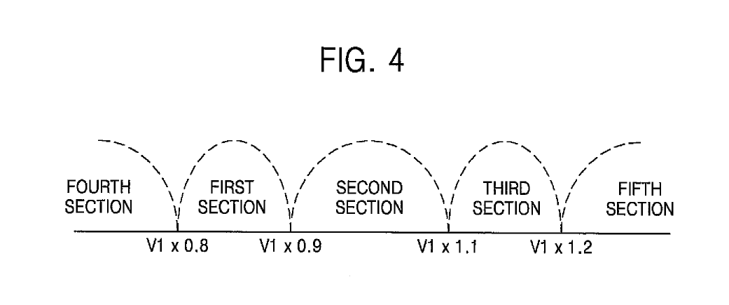

FIG. 4 illustrates a VGA gain value determination (or calculation) with reference to the foregoing third VGA gain value determination according to an embodiment of the inventive concept. Referring to FIG. 4, when the second VGA gain value is included in a first section of a VGA gain value range, (e.g., the second VGA gain value (V2) is greater than 0.8 times the first VGA gain (V1) value but less than 0.9 times V1), the controller 90 may calculate the third VGA gain value (V3) using Equation 1 below.

[V3=(V1+V2)/2] Equation 1

As noted above, in certain more particular embodiments, V2 is included in a second section of the VGA gain value rage, (e.g., V2 is greater than 0.9 times V1 but less than 1.1 times V1), the controller 90 may simply determine that V3 is equal to V2.

In other more particular embodiments, when V2 is included in a third section of the VGA gain value range, (e.g., V2 is greater than 1.1 times V1 but less than 1.2 V1), the controller 90 may calculate V3 according to Equation 1.

In still other more particular embodiments, when V2 is included in a fourth section of the VGA gain value range, (e.g., V2 is less than 0.8 times V1) or when V2 is included in a fifth section of the VGA gain value range, (e.g., V2 is greater than 1.2 times V1), the controller 90 may respectively calculate the third VGA gain value as being equal to 0.8 times V1 or 1.2 V1.

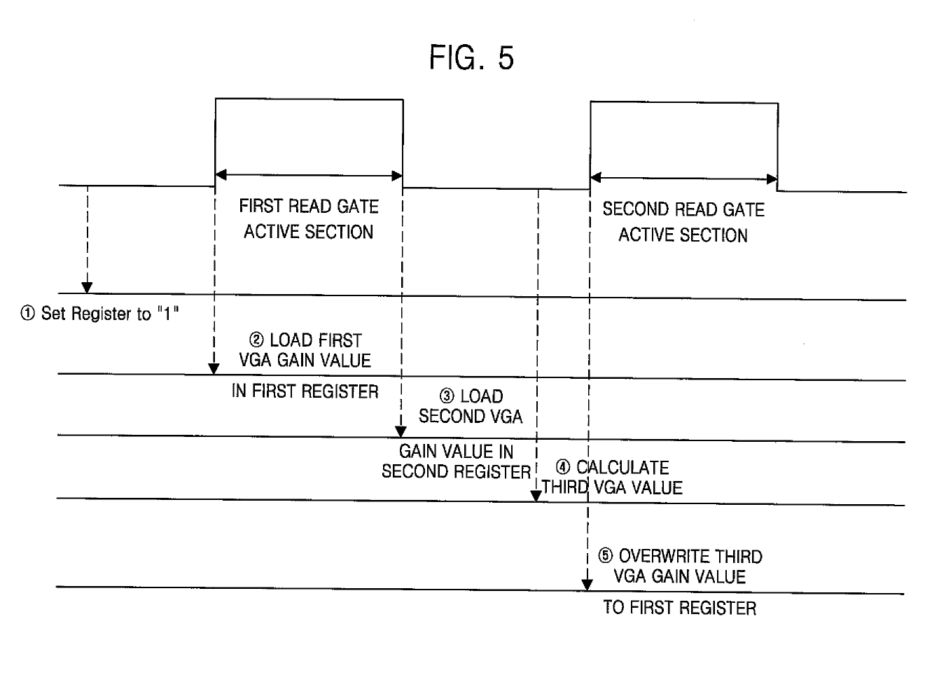

FIG. 5 is a timing diagram further illustrating one possible method of operating a hard disk drive capable of performing VGA gain adjustments like those described with reference to FIGS. 1-4.

Referring to FIGS. 1-5, the controller 90 is assumed to initially set a gain value of “1” to a third register (1). When a first read gate is enabled for a first sector read, the controller 90 then loads the first VGA gain value stored in the first register 70 (2). Upon completion of the first section read, the controller 90 then loads the second VGA gain value stored in the second register 70 (3). Before a second read gate is enabled for second sector read, the controller 90 calculates the third VGA gain value based on (e.g.) the range of the second VGA gain value (4).

When the second read gate is enabled, the controller 90 overwrites the first VGA gain value stored in the first register 70 with the determined (e.g., calculated) third VGA gain value and applies (or sets) the third VGA gain value to be the gain value of the VGA 50 (5). For all subsequent sectors read during operation of the HDD, the above steps may be repeated, as required.

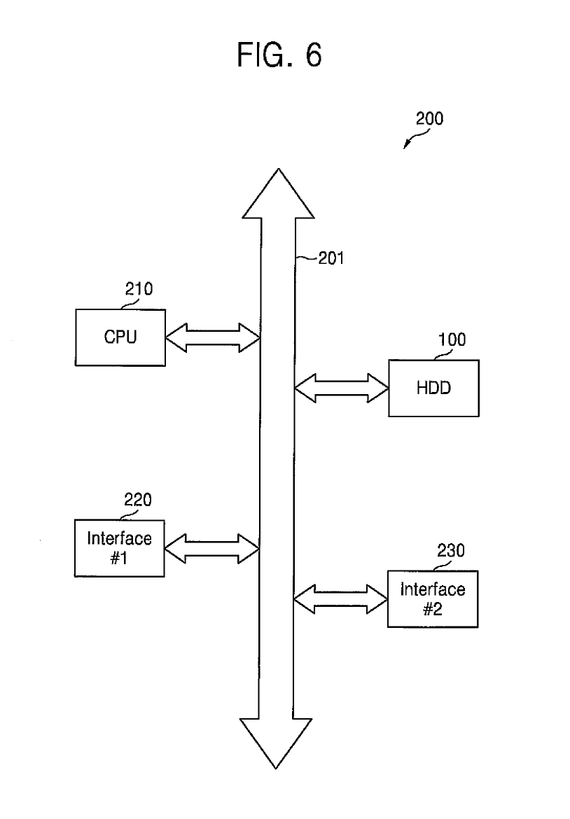

FIG. 6 is a general block diagram of a computational system 200 including the hard disk drive 100 of FIG. 1. Referring to FIG. 6, the computational system 200 may take many different forms including, for example, a personal computer (PC), a notebook computer, a netbook computer, a tablet PC, a portable computer, a handheld communication device, a digital TV, or a home automation device.

The computational system 200 generally comprises the HDD 100 and a CPU 210 connected via a system bus 201. The CPU 210 may control the operation of the computational system 200 during read/write operations directed to the HDD 100.

The HDD 100 may perform the VGA gain adjustment method described above in the context of the exemplary embodiments illustrated in FIGS. 1-4. The computational system 200 may further include a first interface 220, such as an input/output interface. The input/output interface may be an output apparatus such as a monitor or a printer, or an input apparatus such as a mouse, a touch panel, or a keyboard.

The computational system 200 may further include a second interface 230, such as a wireless communications interface facilitating wireless communication with an external device. Thus, the second interface 230 may transmit the data stored in the HDD 100 to an external computer system or store data transmitted by the external computer system in the HDD 100 under the control of the CPU 210.

Within the computational system 200, the HDD 100 may be incorporated within a so-called hybrid HDD additionally including non-volatile memory. Thus, the CPU 210 may store data in the HDD 100 or the non-volatile memory device according to a data storage plan.

As described above, the method for adjusting gain of a VGA according to embodiments of the inventive concept, and certain apparatuses using the method are able to prevent the generation of erroneous amplification feedback caused by abnormal gain value use. Embodiments of the inventive concept are able to correctly determine or calculate an appropriate gain value for desired channel amplification feedback. Thus, an error such as error correction code (ECC), data address mark (DAM), or busy time out (BTO) due to a divergence of gain value may be prevented.

While the inventive concept has been particularly shown and described with reference to exemplary embodiments thereof, it will be understood that various changes in form and details may be made therein without departing from the scope of the following claims.

What is claimed is:

1. A method of adjusting gain of a variable gain amplifier (VGA) in a read/write channel circuit, the method comprising:
loading a first VGA gain value (V1) that is initially optimized to a read channel of the read/write circuit in a first register;
loading a second VGA gain value (V2) that is adapted from V1 in a second register;
determining a third VGA gain value (V3) in accordance with results of operation of the VGA using V1 and V2; and
overwriting V1 with V3 in the first register.

2. The method of claim 1, wherein loading V1 in the first register is performed during a first time period in which a first current read gate is enabled.

3. The method of claim 2, wherein loading V2 in the second register is performed after the first time period and before a second time period in which a second current read gate is enabled.

4. The method of claim 1, further comprising:
setting V2 or V3 to be a gain value controlling the operation of the VGA.

5. The method of claim 1, wherein determining V3 comprises:
if V2 is greater than 0.8 times V1 and less than 0.9 times V1, calculating V3 to be equal to ½ a sum of V1 and V2.

6. The method of claim 1, wherein determining V3 comprises:
if V2 is greater than 0.9 times V1 and less than 1.1 times V1, determining V3 to be equal to V2.

7. The method of claim 1, wherein determining V3 comprises:
if V2 is greater than 1.1 times V1 and less than 1.2 times V1, calculating V3 to be equal to ½ a sum of V1 and V2.

8. The method of claim 1, wherein determining V3 comprises:
if V2 is less than 0.8 times V1, calculating V3 to be equal to 0.8 time V1.

9. The method of claim 1, wherein determining V3 comprises:
if V2 is greater than 1.2 times V1, calculating V3 to be equal to 1.2 times V1.

10. A read/write channel circuit comprising:
a first register that stores a first variable gain amplifier (VGA) gain value (V1) that is read channel optimized;
a second register that stores a second VGA gain value (V2) that is adapted from V1; and
a controller that reads V1 and V2, determines a third VGA gain value (V3) according to results of operation of the VGA in accordance with V1 and V2, and overwrites V1 in the first register with V3.

11. The read/write channel circuit of claim 10, wherein the controller sets the V2 or V3 as a gain value of the VGA in the read/write channel circuit.

12. The read/write channel circuit of claim 10, wherein if V2 is greater than 0.8 times V1 and less than 0.9 times V1, the controller calculates V3 to be equal to ½ a sum of V1 and V2.

13. The read/write channel circuit of claim 10, wherein if V2 is greater than 0.9 times V1 and less than 1.1 times V1, the controller determines V3 to be equal to V2.

14. The read/write channel circuit of claim 10, wherein if V2 is greater than 1.1 times V1 and less than 1.2 times V1, the controller calculates V3 to be equal to ½ a sum of V1 and V2.

15. The read/write channel circuit of claim 10, wherein if V2 is less than 0.8 times V1, the controller calculates V3 to be equal to 0.8 times V1.

16. The read/write channel circuit of claim 10, wherein if V2 is greater than 1.2 times V1, the controller calculates V3 to be equal to 1.2 times V1.

17. A hard disk drive (HHD) comprising:
a magnetic recording medium that stores data;
a spindle motor that rotates the magnetic recording medium;
a head that at least one of amplifies a write signal to write the data to the magnetic recording medium and reads data from the magnetic recording medium;
a pre-amplifier that at least one of amplifies a write signal to write the data via the head and amplifies a read signal output from the head; and
a read/write channel circuit that converts a signal output from the pre-amplifier into read data,
wherein the read/write channel circuit comprises:
a variable gain amplifier (VGA) that amplifies the signal output from the pre-amplifier;
a first register that stores a first VGA gain value (V1) that is read channel optimized;
a second register that stores a second VGA gain value (V2) that is adapted from V1; and
a controller that reads V1 and V2, determines a third VGA gain value (V3) in accordance with results of operation of the VGA using V1 and V2, overwrites V1 in the first register with V3, and sets V2 or V3 as a gain value controlling operation of the VGA.

18. The HHD of claim 17, wherein if V2 is greater than 0.8 times V1 and less than 0.9 times V1, the controller calculates V3 to be equal to ½ a sum of V1 and V2.

19. The HHD of claim 17, wherein if V2 is greater than 0.9 times V1 and less than 1.1 times V1, the controller determines V3 to be equal to V2.

20. The HDD of claim 17, wherein if V2 is greater than 1.1 times V1 and less than 1.2 times V1, the controller calculates V3 to be equal to ½ a sum of V1 and V2.
